(19) United States
(12) Patent Application Publication
(10) Pub. No.: US 2026/0155314 A1
(43) Pub. Date: Jun. 4, 2026

(54) MULTILAYER CERAMIC CAPACITOR

(71) Applicant: Murata Manufacturing Co., Ltd., Nagaokakyo-shi (JP)

(72) Inventors: Kazuhiro NISHIBAYASHI, Nagaokakyo-shi (JP); Takashi SAWADA, Nagaokakyo-shi (JP)

(21) Appl. No.: 19/458,123

(22) Filed: Jan. 23, 2026

Related U.S. Application Data
(63) Continuation of application No. PCT/JP2024/023947, filed on Jul. 2, 2024.

(30) Foreign Application Priority Data
Aug. 2, 2023 (JP) 2023-126522

(51) Int. Cl. H01G 4/30; H01G 4/12; H01G 4/232

(52) U.S. Cl. CPC H01G 4/30; H01G 4/1245; H01G 4/2325

(57) ABSTRACT

A three-terminal multilayer ceramic capacitor includes end-surface external electrodes on end surfaces, and a side-surface external electrode on at least one side surface. An internal electrode includes an end-surface exposed internal electrode exposed on an end surface and connected to the end-surface external electrode, and a side-surface exposed internal electrode on a side surface and connected to the side-surface external electrode. A lengthwise dimension of the side-surface external electrode satisfies about 0.10 mm<Li<about 0.25 mm, and a total dimension Lall and a total dimension Wall satisfy a relationship of about 0.4 Wall≤Lall≤about 1.0 Wall.

### CROSS REFERENCE TO RELATED APPLICATIONS

This application claims the benefit of priority to Japanese Patent Application No. 2023-126522 filed on Aug. 2, 2023 and is a Continuation Application of PCT Application No. PCT/JP2024/023947 filed on Jul. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Recently, reducing the impedance of electronic circuit lines has become important, particularly for mobile device products. For the purpose of reducing the impedance of electronic circuit lines, three-terminal multilayer ceramic capacitors for decoupling applications are widely used. A three-terminal multilayer ceramic capacitor includes a multilayer body including an inner layer portion in which dielectric layers including end surface internal electrodes exposed at end surfaces thereon and dielectric layers including lateral surface internal electrodes exposed at lateral surfaces thereon are alternately laminated in a plurality of layers, and outer layer portions provided on one side and the other side in the lamination direction of the inner layer portion. The three-terminal multilayer ceramic capacitor further includes end surface external electrodes provided on the end surfaces, and lateral surface external electrodes provided on the lateral surfaces (see, for example, Japanese Unexamined Patent Application Publication No. 2013-201417).

A reduction in size of the three-terminal multilayer ceramic capacitor enables a further reduction in impedance in high-frequency characteristics. The impedance reduction resulting from a reduction in size is derived from a decrease in the Equivalent Series Inductance (hereinafter referred to as “ESL”) possessed by the multilayer ceramic capacitor.

As three-terminal multilayer ceramic capacitors are reduced in size, particularly the lateral surface external electrodes also become smaller. Consequently, the bonding length (area) between the lateral surface external electrodes and the lateral surface extension electrodes becomes smaller, such that the bonding strength of the lateral surface external electrodes to the multilayer body decreases, and the lateral surface external electrodes become more likely to peel off due to external impact.

### SUMMARY OF THE INVENTION

Example embodiments of the present invention provide multilayer ceramic capacitors each with a reduced possibility of peeling of lateral surface external electrodes from the multilayer body.

A three-terminal multilayer ceramic capacitor according to an example embodiment of the present invention includes a multilayer body including an inner layer portion including a plurality of dielectric layers and a plurality of internal electrodes that are alternately laminated in a lamination direction, end surface external electrodes each on a corresponding one of both end surfaces of the multilayer body in a length direction intersecting the lamination direction, and a lateral surface external electrode on at least one of lateral surfaces of the multilayer body in a width direction intersecting the lamination direction and the length direction. The plurality of internal electrodes include end surface exposed internal electrodes each exposed at the end surfaces and connected to the end surface external electrodes, and lateral surface exposed internal electrodes each exposed at a corresponding one of the lateral surfaces and connected to the lateral surface external electrode. A dimension Li of the lateral surface external electrode in the length direction satisfies about 0.10 mm<Li<about 0.25 mm, and a total dimension Lall, which denotes a sum of respective dimensions in the length direction of lateral surface bonding electrodes including lateral surface extension portions of the lateral surface exposed internal electrodes each exposed at one of the lateral surfaces and connected to the lateral surface external electrode, satisfies a relationship of about 0.4 Wall≤Lall≤about 1.0 Wall with respect to a total dimension Wall, which denotes a sum of respective dimensions in the width direction of end surface extension portions of the end surface exposed internal electrodes each exposed at one of the end surfaces and connected to the end surface external electrodes.

According to example embodiments of the present invention, multilayer ceramic capacitors each with a reduced possibility of peeling of lateral surface external electrodes from the multilayer body are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1 according to an example embodiment of the present invention.

FIG. 2 is a cross-sectional view of the multilayer ceramic capacitor 1 taken along the II-II direction in FIG. 1.

FIG. 3 is a cross-sectional view of the multilayer ceramic capacitor 1 taken along the III-III direction in FIG. 1.

FIG. 4 is a cross-sectional view along an end surface exposed internal electrode 15A of a multilayer ceramic capacitor 1 according to an example embodiment of the present invention.

FIG. 5 is a cross-sectional view along a lateral surface exposed internal electrode 15B of a multilayer ceramic capacitor 1 according to an example embodiment of the present invention.

FIG. 6 is a diagram explaining an example of a manufacturing process of a multilayer body 2 in a method of manufacturing a multilayer ceramic capacitor 1 according to an example embodiment of the present invention.

FIG. 7 is a flowchart explaining an example of a method of manufacturing a multilayer ceramic capacitor 1 according to an example embodiment of the present invention.

### DETAILED DESCRIPTION OF THE EXAMPLE EMBODIMENTS

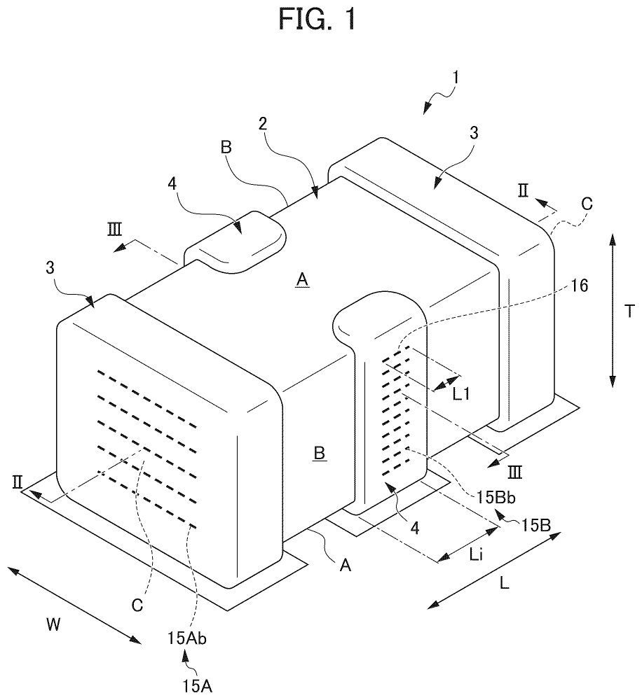

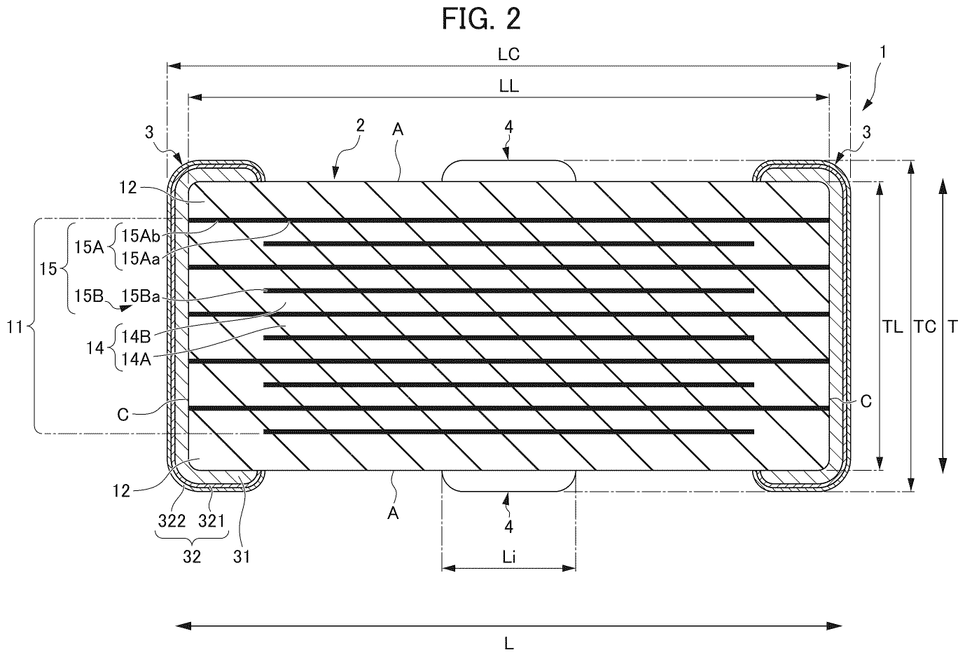

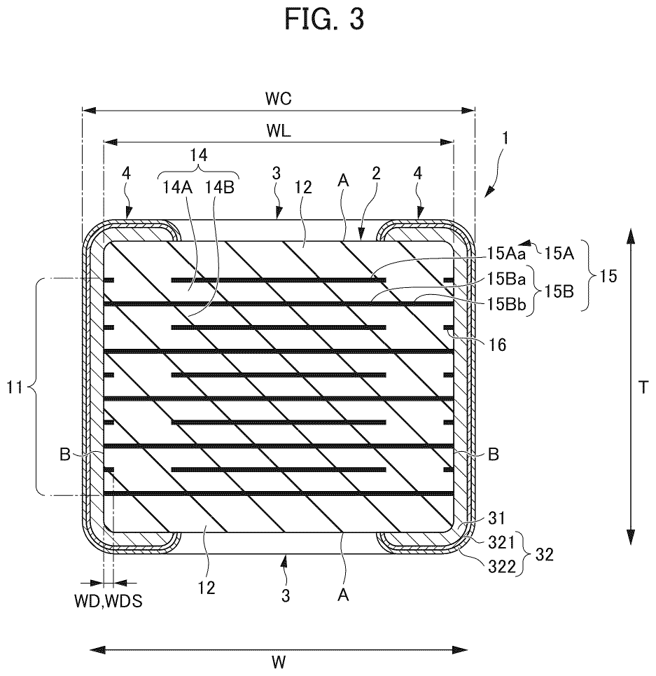

Hereinafter, multilayer ceramic capacitors according to example embodiments of the present invention will be described. FIG. 1 is a schematic perspective view of a multilayer ceramic capacitor 1 according to an example embodiment of the present invention. FIG. 2 is a cross-sectional view of the multilayer ceramic capacitor 1 taken along the II-II direction in FIG. 1. FIG. 3 is a cross-sectional view of the multilayer ceramic capacitor 1 taken along the III-III direction in FIG. 1.

The multilayer ceramic capacitor 1 is a three-terminal multilayer ceramic capacitor 1 including a multilayer body 2, end surface external electrodes 3 provided on both end surfaces C in the length direction L of the multilayer body 2, and lateral surface external electrodes 4 provided on both lateral surfaces B in the width direction W of the multilayer body 2. The multilayer body 2 includes an inner layer portion 11 in which dielectric layers 14 and internal electrodes 15 are laminated, and outer layer portions 12.

In the present specification, as terms representing the orientation of the multilayer ceramic capacitor 1, the direction in which the dielectric layers 14 and the internal electrodes 15 are laminated in the multilayer ceramic capacitor 1 is defined as the lamination direction T. The direction intersecting the lamination direction T and in which the pair of end surface external electrodes 3 are provided is defined as the length direction L. The direction intersecting both the length direction L and the lamination direction T is defined as the width direction W. In the description of example embodiments, the lamination direction T, the length direction L, and the width direction W are orthogonal or substantially orthogonal to each other.

In the following description, among the six outer surfaces of the multilayer body 2, a pair of outer surfaces provided on both sides in the lamination direction T are defined as main surfaces A, a pair of outer surfaces extending in the lamination direction T and provided on both sides in the width direction W are defined as lateral surfaces B, and a pair of outer surfaces extending in the lamination direction T and provided on both sides in the length direction L are defined as end surfaces C.

The multilayer ceramic capacitor 1 shown in FIG. 2 or FIG. 3 has, for example, a dimension LC in the length direction L of about 0.1 mm or more and about 0.70 mm or less, a dimension WC in the width direction W of about 0.05 mm or more and about 0.40 mm or less, and a dimension TC in the lamination direction T of about 0.10 mm or more and about 0.55 mm or less.

Furthermore, for example, the capacitance of the multilayer ceramic capacitor 1 is about 0.022 μF or more and about 10 μF or less, and preferably about 1.0 μF or more and about 2.2 μF or less. The ESL of the multilayer ceramic capacitor 1 is, for example, about 65 7 pH or less at about 100 MHz, and preferably about 50 pH or less at about 1 GHz.

The capacitance of the multilayer ceramic capacitor 1 can be obtained using, for example, an LCR meter (available from Agilent Technologies, model number: E4980A) under conditions of about 1 kHz and about 0.5 Vrms. The ESL of the multilayer ceramic capacitor 1 can be obtained by, for example, calculation from measured values of impedance at a predetermined frequency using a network analyzer (available from Agilent Technologies, model number: E5080A).

The multilayer body 2 includes an inner layer portion 11 and outer layer portions 12 provided on both sides of the inner layer portion 11 in the lamination direction T. It is preferable that the multilayer body 2 include rounded corner portions and ridge portions. The corner portions refer to portions where three surfaces of the multilayer body 2 intersect, and the ridge portions refer to portions where two surfaces of the multilayer body 2 intersect.

The dimensions of the multilayer body 2 shown in FIG. 2 or FIG. 3 are as follows: the dimension LL in the length direction L is about 0.09 mm or more and about 0.69 mm or less, the dimension WL in the width direction W is about 0.04 mm or more and about 0.39 mm or less, and the dimension TL in the lamination direction T is about 0.09 mm or more and about 0.54 mm or less, for example.

The inner layer portion 11 includes a plurality of dielectric layers 14 and a plurality of internal electrodes 15 laminated along the lamination direction T.

The dielectric layers 14 are each made of a ceramic material. As the ceramic material, for example, a ceramic material including as a main component a ceramic material including at least one of Ca, Zr, and Ti may be used. Specifically, for example, a ceramic material having a perovskite structure represented by a general formula ABO₃ including Ca and Zr may be used as a main component. Examples of such ceramic materials having a perovskite structure include, but are not limited to, BaTiO₃ (barium titanate) and CaZrO₃ (calcium zirconate). Further, for example, the main component of the ceramic material of the dielectric layers 14 may include all of Ca, Zr, and Ti.

The internal electrodes 15 are each preferably made of a metal material such as, for example, Ni, Cu, Ag, Pd, Ag—Pd alloy, Au, or the like.

The internal electrodes 15 include a plurality of end surface exposed internal electrodes 15A and a plurality of lateral surface exposed internal electrodes 15B that are alternately provided. When it is not necessary to particularly distinguish between the end surface exposed internal electrodes 15A and the lateral surface exposed internal electrodes 15B, they are collectively described as internal electrodes 15.

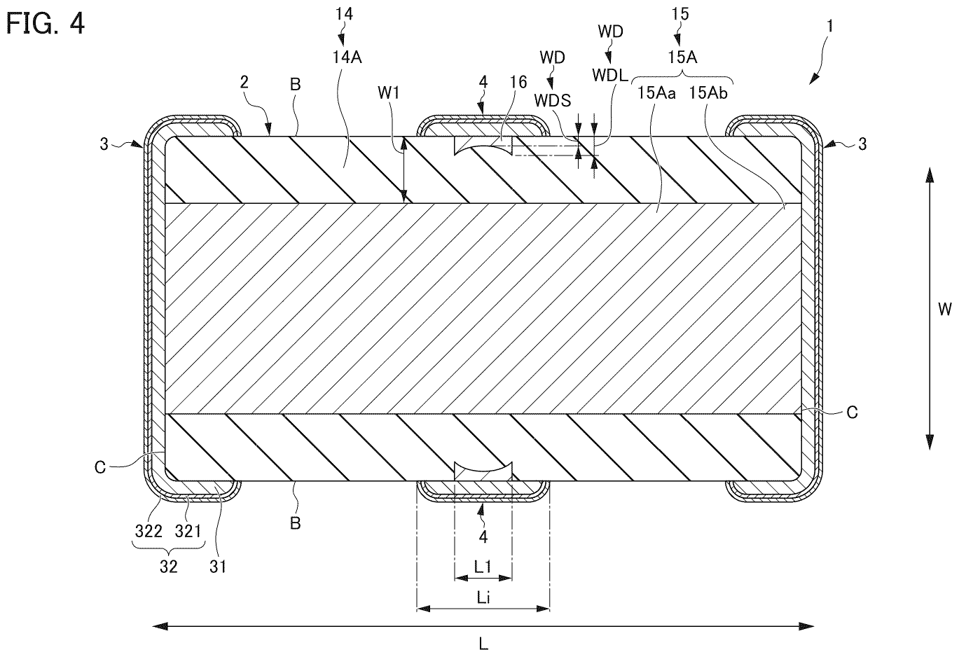

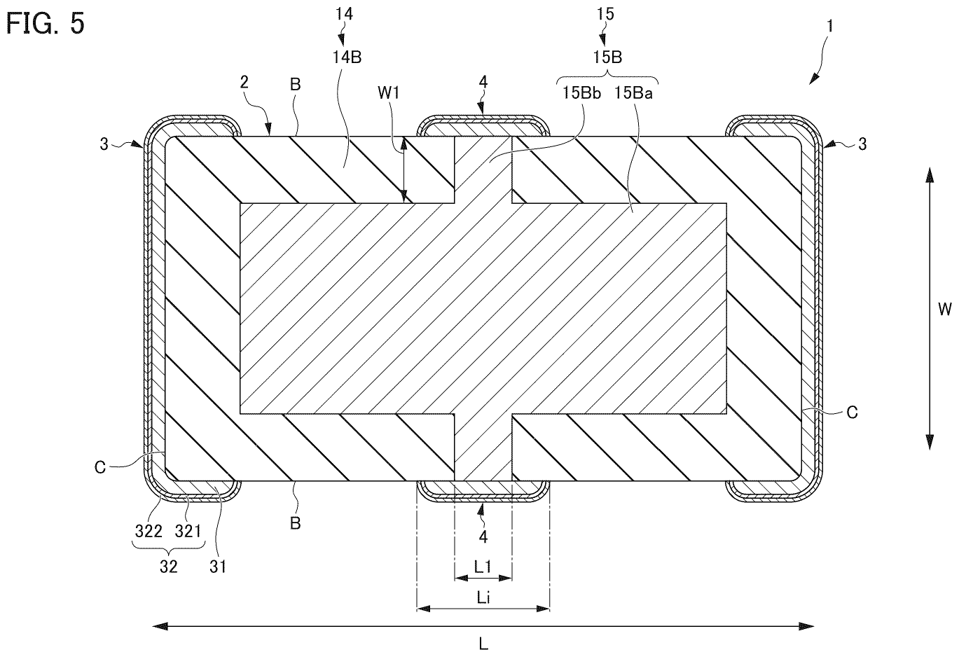

FIG. 4 is a cross-sectional view along the end surface exposed internal electrodes 15A of the multilayer ceramic capacitor 1. FIG. 5 is a cross-sectional view along the lateral surface exposed internal electrodes 15B of the multilayer ceramic capacitor 1.

As shown in FIG. 4, the end surface exposed internal electrode 15A extends between both end surfaces C in the length direction L of the multilayer body 2, and is spaced apart from both lateral surfaces B in the width direction W by a fixed distance W1. The end surface exposed internal electrode 15A includes an end surface counter portion 15Aa located in the middle portion between both end surfaces C, and end surface extension portions 15Ab extending from the end surface counter portion 15Aa toward both end surfaces C. In the example embodiments, the end surface counter portion 15Aa and the end surface extension portions 15Ab have equal or substantially equal dimensions in the width direction W, and the end surface exposed internal electrode 15A is rectangular or substantially rectangular as a whole combining the end surface counter portion 15Aa and the end surface extension portions 15Ab. The end surface extension portions 15Ab extending from the end surface counter portion 15Aa toward both end surfaces C each extend toward both end surfaces C and are exposed at the end surfaces C of the multilayer body 2, and are connected to the end surface external electrodes 3 provided on both end surfaces C in the length direction L of the multilayer body 2.

As shown in FIG. 5, the lateral surface exposed internal electrode 15B includes a lateral surface counter portion 15Ba located in the middle between both lateral surfaces B, and lateral surface extension portions 15Bb extending from the lateral surface counter portion 15Ba toward both lateral surfaces B. The lateral surface counter portion 15Ba has a rectangular or substantially rectangular shape that is slightly smaller than the multilayer body 2, and is spaced apart from both lateral surfaces B in the width direction W by a fixed distance W1.

The dimension L1 of the lateral surface extension portions 15Bb in the length direction L is smaller than the dimension of the lateral surface counter portion 15Ba in the length direction L. The lateral surface extension portions 15Bb extend toward both lateral surfaces B and are exposed at the lateral surfaces B of the multilayer body 2, and are bonded to the lateral surface external electrodes 4 provided on both lateral surfaces of the multilayer body 2 in the width direction W.

The end surface counter portion 15Aa and the lateral surface counter portion 15Ba are opposed to each other to provide a capacitor portion.

As shown in FIG. 4, in the example embodiments, dummy electrodes 16 are provided on the lateral surfaces B where the end surface exposed internal electrodes 15A are not exposed in the first dielectric layer 14A where the end surface exposed internal electrode 15A is provided. The dummy electrodes 16 are exposed at the lateral surfaces B.

The dummy electrodes 16 and the lateral surface extension portions 15Bb are both exposed at the lateral surface B and bonded to the lateral surface external electrode 4. In the present specification, the dummy electrode 16 and the lateral surface extension portion 15Bb are collectively referred to as lateral surface bonding electrodes. In the example embodiments, the dimensions of the dummy electrode 16 and the lateral surface extension portion 15Bb in the length direction L are equal or substantially equal, both being L1, where about 0.04 mm<L1<about 0.100 mm, for example.

The total dimension of the lateral surface bonding electrodes including the dummy electrodes 16 and the lateral surface extension portions 15Bb, that is, the dimension Lall including the total dimension (length) of all the dimensions of each of the plurality of dummy electrodes 16 and the total dimension (length) of all the dimensions of each of the plurality of lateral surface extension portions 15Bb, is, for example, about 3 mm<Lall<about 40 mm, and preferably about 12 mm<Lall<about 25 mm. Although not limited thereto, in the example embodiments, the number of dummy electrodes 16 and the number of lateral surface extension portions 15Bb are the same, which is n, and the dummy electrodes 16 and the lateral surface extension portions 15Bb are alternately laminated. Furthermore, in the example embodiments, the plurality of dummy electrodes 16 all have the same or substantially the same length L1, the plurality of lateral surface extension portions 15Bb all have the same or substantially the same length L1, and the dummy electrode 16 and the lateral surface extension portion 15Bb have the same or substantially the same length L1. In this case, Lall is n (number of dummy electrodes 16)×L1 (length of dummy electrode 16)+n (number of lateral surface extension portions 15Bb)×L1 (length of lateral surface extension portion 15Bb), that is, Lall=2nL1.

When the total dimension of the respective dimensions in the width direction of the end surface extension portions 15Ab is defined as Wall, for example, Lall and Wall have the relationship of about 0.4 Wall≤Lall≤about 1.0 Wall.

Each of the dummy electrodes 16 has a recessed shape in the cross-sectional view shown in FIG. 4. That is, each of the dummy electrodes 16 includes the side exposed at the lateral surface B and the side opposite thereto. These sides are not parallel to each other in the length direction L. Further, each of the dummy electrodes 16 is curved such that the dimension WD in the width direction W at the middle portion becomes smaller. Each of the dummy electrodes 16 preferably has a maximum dimension WDL of, for example, about 20% or more and about 80% or less of the dimension W1 (that is, the separation distance from the lateral surface B of the end surface exposed internal electrode 15A shown in FIG. 4) of the lateral surface extension portion 15Bb shown in FIG. 5, and a minimum dimension WDS of 1% or more and 50% or less of W1.

In the example embodiments, the difference in thickness in the lamination direction T among the end surface exposed internal electrodes 15A, the lateral surface exposed internal electrodes 15B, and the dummy electrodes 16 is, for example, within about ±10% and is equal or substantially equal.

The dielectric layers 14 include a plurality of first dielectric layers 14A and a plurality of second dielectric layers 14B which are alternately laminated. The end surface exposed internal electrode 15A and the dummy electrode 16 exposed at the end surface C are provided on each of the plurality of first dielectric layers 14A, and the lateral surface exposed internal electrode 15B exposed at a portion of the lateral surface B is provided on each of the plurality of second dielectric layers 14B.

With reference to FIG. 2 and FIG. 3 again, each of the outer layer portions 12 is a dielectric layer provided adjacent to the main surface A of the inner layer portion 11. Each of the outer layer portions 12 is made of the same material as the dielectric layers 14 of the inner layer portion 11.

The end surface external electrodes 3 are provided on both end surfaces C of the multilayer body 2. The end surface extension portions 15Ab of the end surface exposed internal electrodes 15A are connected to the end surface external electrodes 3. The end surface external electrodes 3 cover not only the end surfaces C, but also portions of the main surfaces A and the lateral surfaces B adjacent to the end surfaces C.

The lateral surface external electrodes 4 are provided on both lateral surfaces B of the multilayer body 2. The lateral surface extension portions 15Bb of the lateral surface exposed internal electrodes 15B are connected to the lateral surface external electrodes 4. The lateral surface external electrodes 4 cover not only the lateral surfaces B, but also a portion of the main surfaces A adjacent to the lateral surfaces B. In the example embodiments, the dimension Li in the length direction L of each of the lateral surface external electrodes 4 is, for example, about 0.10 mm<Li<about 0.25 mm.

Each of the end surface external electrodes 3 and each of the lateral surface external electrodes 4 include a base electrode layer 31 and a plated layer 32 provided on the base electrode layer 31. The plated layer 32 includes, for example, a Ni (nickel) plated layer 321 provided on the base electrode layer 31 and a Sn (tin) plated layer 322 provided on the Ni plated layer 321. However, the present invention is not limited to such a configuration, and each of the end surface external electrodes 3 and each of the lateral surface external electrodes 4 may have a configuration in which, for example, the base electrode layer 31 is made of Ni, and a Cu plated layer, a Ni plated layer, and a Sn plated layer are sequentially provided thereon.

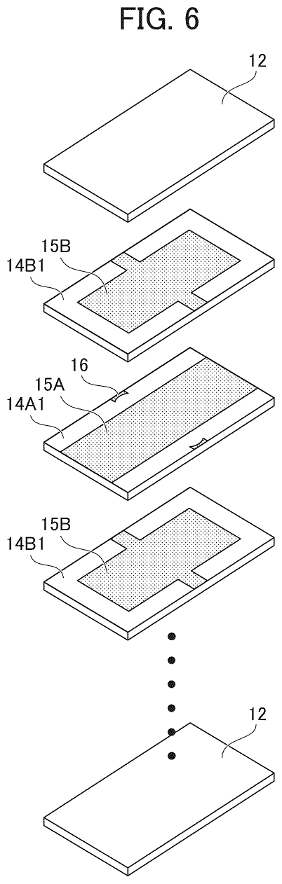

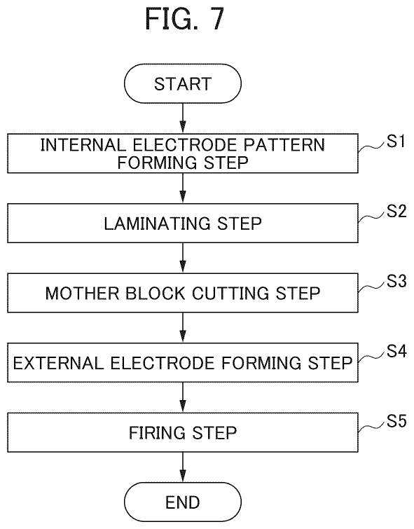

Next, an example of a method of manufacturing the multilayer ceramic capacitor 1 according to an example embodiment of the present invention will be described. FIG. 6 is a diagram explaining the manufacturing steps of the multilayer body 2 in the method of manufacturing the multilayer ceramic capacitor 1. FIG. 7 is a flowchart explaining the method of manufacturing the multilayer ceramic capacitor 1.

The internal electrode pattern forming step S1 includes an end surface exposed internal electrode forming step S11 and a lateral surface exposed internal electrode forming step S12.

The end surface exposed internal electrode 15A and recessed dummy electrodes 16 are formed using an electrically conductive paste on a ceramic green sheet 14A1 defining and functioning as the first dielectric layer 14A. The dummy electrodes 16 may be formed simultaneously with the end surface exposed internal electrode 15A, or the dummy electrodes 16 may be formed by, for example, inkjet printing after forming the end surface exposed internal electrode 15A.

Similarly, the lateral surface exposed internal electrode 15B is formed using an electrically conductive paste on a ceramic green sheet 14B1 defining and functioning as the second dielectric layer 14B.

The ceramic green sheet 14A1 and the ceramic green sheet 14B1 described below are strip-shaped sheets formed by shaping a ceramic slurry including ceramic powder, a binder, and a solvent into a sheet form on a carrier film using a die coater, gravure coater, micro gravure coater, or the like, for example.

The end surface exposed internal electrode 15A and the lateral surface exposed internal electrode 15B are formed by, for example, printing such as screen printing, gravure printing, or relief printing.

The ceramic green sheets 14A1 that define and function as the first dielectric layers 14A on which the end surface exposed internal electrodes 15A are provided and the ceramic green sheets 14B1 that define and function as the second dielectric layers 14B on which the lateral surface exposed internal electrodes 15B are provided are alternately laminated.

Subsequently, ceramic green sheets for manufacturing the outer layer portions 12 are provided on the upper and lower sides and thermocompression bonded to form a mother block.

Next, the mother block is cut and divided in the length direction L and the width direction W to manufacture a plurality of rectangular or substantially rectangular parallelepiped multilayer bodies 2.

Next, the lateral surface external electrodes 4 are formed on both lateral surfaces B of the multilayer body 2. The lateral surface extension portions 15Bb of the lateral surface exposed internal electrodes 15B are connected to the lateral surface external electrodes 4. The lateral surface external electrodes 4 are formed to cover not only the lateral surfaces B, but also portions of the main surfaces A adjacent to the lateral surfaces B.

Then, end surface external electrodes 3 are formed on both end surfaces C of the multilayer body 2. The end surface extension portions 15Ab of the end surface exposed internal electrodes 15A are connected to the end surface external electrodes 3. The end surface external electrodes 3 are formed to cover not only the end surfaces C, but also portions of the main surfaces A and portions of lateral surfaces B adjacent to the end surfaces C.

Then, heating is performed for a predetermined time in a nitrogen atmosphere at a set firing temperature. Thus, the end surface external electrodes 3 and the lateral surface external electrodes 4 are fired on the multilayer body 2 to manufacture the multilayer ceramic capacitor 1 shown in FIG. 1.

As described above, the multilayer ceramic capacitor 1 of the above-described example embodiment has the following advantageous effects.

In a multilayer ceramic capacitor where the dimension Li of the lateral surface external electrode 4 in the length direction L is relatively small at, for example, about 0.10 mm<Li<about 0.25 mm, the dimension of the lateral surface extension portion 15Bb in the length direction L also becomes small, and the bonding length between the lateral surface external electrode 4 and the lateral surface extension portion 15Bb becomes short (the bonding area becomes small).

In this case, unlike the example embodiments described above, if the lateral surface external electrode 4 is bonded to the multilayer body 2 only by bonding with the lateral surface extension portion 15Bb, the bonding strength between the lateral surface external electrode 4 and the lateral surface extension portion 15Bb is small, such that the lateral surface external electrode 4 is likely to peel off from the multilayer body 2.

However, in the example embodiments described above, the lateral surface external electrode 4 is bonded not only to the lateral surface extension portion 15Bb, but also to the dummy electrodes 16. Therefore, the bonding strength of the lateral surface external electrode 4 to the multilayer body 2 becomes strong, making it less likely to peel off.

In the laminating step S2 described above, the end surface counter portion 15Aa of the ceramic green sheet 14A1 and the lateral surface counter portion 15Ba of the ceramic green sheet 14B1 are laminated in an overlapping manner. However, the end surface extension portions 15Ab of the ceramic green sheet 14A1 and the lateral surface extension portions 15Bb of the ceramic green sheet 14B1 do not overlap. Therefore, when the dummy electrodes 16 are not provided, unlike the example embodiments described above, the portion where the extension portion is provided becomes thinner in the lamination direction T compared to the portion where the counter portion is provided. This makes uniform pressurization difficult during mother block formation.

However, according to the example embodiments described above, the dummy electrodes 16 are provided on the ceramic green sheet 14A1. Therefore, when laminating this ceramic green sheet 14A1 and the ceramic green sheet 14B1, the thickness in the lamination direction T at the location adjacent to the lateral surface B is maintained uniformly compared to the case where the dummy electrodes 16 are not provided. As a result, the lateral surface extension portion 15Bb in contact with the lateral surface B is instantaneously pressurized and densified during thermocompression bonding after lamination in the laminating step S2. Therefore, flow of the extension portion during thermocompression bonding is reduced or prevented, and the thickness of the lateral surface extension portion 15Bb in contact with the region B is maintained thick. This improves the bonding property between the lateral surface extension portions 15Bb in contact with the lateral surface B and the lateral surface external electrodes 4, and it is possible to reduce the equivalent series inductance (ESL).

In the example embodiments described above, each of the dummy electrodes 16 includes a recessed shape in the cross-sectional view shown in FIG. 4. That is, each of the dummy electrodes 16 includes a portion where the dimension WD in the width direction W is reduced in the cross section passing through the length direction L and the width direction W. The maximum dimension WDL in the width direction W is, for example, about 20% or more and about 80% or less of the dimension W1 of the lateral surface extension portion, and the minimum dimension WDS is, for example, about 1% or more and about 50% or less of the dimension W1 of the lateral surface extension portion. Therefore, compared to a case where a dummy electrode has a rectangular or substantially rectangular shape, each of the dummy electrodes 16 is provided with a portion that is farther away from the end surface exposed internal electrode 15A, such that short circuits are less likely to occur.

Although example embodiments of the present invention have been described above, the present invention is not limited to the above-described example embodiments, and various changes and modifications thereto can be made, including, for example, the following.

In the example embodiments described above, the dimension of each of the dummy electrodes 16 in the length direction L and the dimension of each of the lateral surface extension portions 15Bb in the length direction L are equal or substantially equal, and the dimension of each of the dummy electrodes 16 in the length direction L and the dimension of each of the lateral surface extension portions 15Bb in the length direction L are both defined as L1. However, the present invention is not limited to this, and different dimensions may be used, for example, within the range covered by the lateral surface external electrode 4, such as the dimension of each of the dummy electrodes 16 in the length direction L may be made larger than the dimension of each of the lateral surface extension portions 15Bb in the length direction L.

In the example embodiments described above, the thickness in the lamination direction T of each of the end surface exposed internal electrodes 15A and each of the lateral surface exposed internal electrodes 15B are equal or substantially equal, and by further providing the dummy electrodes 16 with the same or substantially the same thickness, the bonding area between the lateral surface external electrode 4 and the lateral surface bonding electrode is increased. However, the present invention is not limited to this, and the bonding area between the lateral surface external electrode 4 and the lateral surface bonding electrode may be increased by, for example, increasing the dimension (thickness) of each of the lateral surface extension portions 15Bb in the lamination direction T.

From the viewpoint of equalizing the balance between the bonding force between the end surface external electrode 3 and the multilayer body 2 and the bonding force between the lateral surface external electrode 4 and the multilayer body 2, the dimension in the width direction W of the end surface extension portion 15Ab connected to the end surface external electrode 3 may be reduced.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including an inner layer portion including a plurality of dielectric layers and a plurality of internal electrodes that are alternately laminated in a lamination direction;
end surface external electrodes each on a corresponding one of end surfaces of the multilayer body in a length direction intersecting the lamination direction; and
a lateral surface external electrode on at least one of lateral surfaces of the multilayer body in a width direction intersecting the lamination direction and the length direction; wherein
the plurality of internal electrodes include:
end surface exposed internal electrodes each exposed at the end surfaces and connected to the end surface external electrodes; and
lateral surface exposed internal electrodes each exposed at a corresponding one of the lateral surfaces and connected to the lateral surface external electrode;
a dimension Li of the lateral surface external electrode in the length direction satisfies about 0.10 mm<Li<about 0.25 mm; and
a total dimension Lall, which denotes a sum of respective dimensions in the length direction of lateral surface bonding electrodes including lateral surface extension portions of the lateral surface exposed internal electrodes each exposed at one of the lateral surfaces and connected to the lateral surface external electrode, satisfy a relationship about 0.4 Wall≤Lall≤about 1.0 Wall with respect to a total dimension Wall, which denotes a sum of respective dimensions in the width direction of end surface extension portions of the end surface exposed internal electrodes each exposed at one of the end surfaces and connected to the end surface external electrodes.

2. The multilayer ceramic capacitor according to claim 1, wherein a width L1 in the length direction of each of the lateral surface bonding electrodes satisfies about 0.04 mm<L1<about 0.100 mm.

3. The multilayer ceramic capacitor according to claim 1, wherein the total dimension Lall of the lateral surface bonding electrodes satisfies about 3 mm<Lall<about 40 mm.

4. The multilayer ceramic capacitor according to claim 1, wherein a dimension of the multilayer body in the lamination direction is about 0.10 mm or more and about 0.50 mm or less.

5. The multilayer ceramic capacitor according to claim 1, wherein the lateral surface bonding electrodes include dummy electrodes.

6. The multilayer ceramic capacitor according to claim 5, wherein each of the dummy electrodes includes a portion in which a dimension WD in the width direction becomes smaller in a cross section passing through the length direction and the width direction, and a maximum dimension WDL of each of the dummy electrodes in the width direction is about 20% or more and about 80% or less of a dimension W1 of each of the lateral surface extension portions, and a minimum dimension WDS of each of the lateral surface extension portions is about 1% or more and about 50% or less of the dimension W1 of each of the lateral surface extension portions.

7. The multilayer ceramic capacitor according to claim 1, wherein
a dimension in the length direction is about 0.1 mm or more and about 0.70 mm or less;
a dimension in the width direction is about 0.05 mm or more and about 0.40 mm or less; and
a dimension in the lamination direction is 0.10 mm or more and 0.55 mm or less.

8. The multilayer ceramic capacitor according to claim 1, wherein a capacitance is about 0.022 μF or more and about 10 μF or less.

9. The multilayer ceramic capacitor according to claim 1, wherein an equivalent series inductance is about 65 pH or less at about 100 MHz and about 50 pH or less at about 1 GHz.

10. The multilayer ceramic capacitor according to claim 1, wherein a capacitance is about 1.0 μF or more and about 2.2 μF or less.

11. The multilayer ceramic capacitor according to claim 1, wherein the multilayer body includes rounded corner portions and ridge portions.

12. The multilayer ceramic capacitor according to claim 1, wherein the multilayer body includes dimensions of about 0.09 mm or more and about 0.69 mm or less in the length direction, about 0.04 mm or more and about 0.39 mm or less in the width direction, and about 0.09 mm or more and about 0.54 mm or less in the lamination direction.

13. The multilayer ceramic capacitor according to claim 1, wherein the plurality of dielectric layers include ceramic material.

14. The multilayer ceramic capacitor according to claim 13, wherein the ceramic material includes at least one of Ca, Zr, or Ti.

15. The multilayer ceramic capacitor according to claim 13, wherein the ceramic material has a perovskite structure including Ca and Zr.

16. The multilayer ceramic capacitor according to claim 13, wherein the ceramic material includes barium titanate and calcium zirconate.

17. The multilayer ceramic capacitor according to claim 13, wherein the ceramic material includes Ca, Zr, and Ti.

18. The multilayer ceramic capacitor according to claim 1, wherein the plurality of internal electrodes include Ni, Cu, Ag, Pd, an Ag—Pd alloy, or Au.

19. The multilayer ceramic capacitor according to claim 1, wherein each of the end surface external electrodes and the lateral surface external electrode includes a base electrode layer and a plated layer.

20. The multilayer ceramic capacitor according to claim 19, wherein the plated layer includes a Ni plated layer and a Sn plated layer.
